(19) United States
(12) Patent Application Publication
(10) Pub. No.: US 2015/0271863 A1
(43) Pub. Date: Sep. 24, 2015

(54) COMMUNICATION APPARATUS, COMMUNICATION SYSTEM, AND RECORDING MEDIUM STORING A COMMUNICATION SYSTEM CONTROL PROGRAM

(71) Applicant: Kengo MATSUYAMA, Tokyo (JP)

(72) Inventor: Kengo MATSUYAMA, Tokyo (JP)

(21) Appl. No.: 14/658,628

(22) Filed: Mar. 16, 2015

(30) Foreign Application Priority Data
Mar. 18, 2014 (JP) 2014-054839

(51) Int. Cl. H04W 76/02; H04W 4/00

(52) U.S. Cl. CPC H04W 76/023; H04W 76/021; H04W 4/008

(57) ABSTRACT

A communication apparatus includes a transmission unit that transfers connectivity information indicating that communication can be established, a storage unit that stores connection information for establishing communication with a previous communication destination acquired from the previous communication destination, an acceptance unit that accepts an instruction to establish communication with a communication destination whose connection information is stored in the storage unit while the transmission unit is transferring the connectivity information, and a first request unit that requests the communication destination to establish communication using the connection information stored in the storage unit for the communication destination in accordance with the instruction received by the receiving unit.

### CROSS-REFERENCE TO RELATED APPLICATION

This patent application is based on and claims priority pursuant to 35 U.S.C. §119(a) to Japanese Patent Application No. 2014-054839, filed on Mar. 18, 2014 in the Japan Patent Office, the entire disclosure of which is hereby incorporated by reference herein.

### BACKGROUND

1. Technical Field

The present invention relates to a communication apparatus, a communication system, and a recording medium storing a communication system control program.

2. Background Art

A technology called “Wi-Fi Direct” that connects one device to another directly without being relayed through an access point is known. One advantage of such peer-to-peer connection is the ability to link devices made by different manufacturers.

With Wi-Fi Direct, devices compatible with the technology can work in two ways, group owner (a wireless base) and client (a wireless slave). In establishing communication, it is determined which device becomes the base and which device becomes the slave after negotiation, and communication is performed in accordance with the determined role.

With printers, Wi-Fi Direct is used because it enables tablets and laptop personal computers (PCs) to print easily, and products compatible with Wi-Fi Direct technology have been released. Generally, the Wi-Fi Direct function is usually disabled (turned off), and enabled when it is desired to link one device with another directly.

Additionally, a technology related to Wi-Fi Direct has been proposed that determines which device becomes the base (group owner) and which device becomes the slave (client) in establishing a connection easily using connection history.

For example, it is considered to be general that a printer is connected to an intranet ordinarily and Wi-Fi Direct mode is enabled only when the tablet device or the note PC prints out by using the printer to communicate with those apparatuses.

### SUMMARY

An example embodiment of the present invention provides a novel communication apparatus that includes a transmission unit that transfers connectivity information indicating that communication can be established, a storage unit that stores connection information for establishing communication with a previous communication destination acquired from the previous communication destination, an acceptance unit that accepts an instruction to establish communication with a communication destination whose connection information is stored in the storage unit while the transmission unit is transferring the connectivity information, and a first request unit that requests the communication destination to establish communication using the connection information stored in the storage unit for the communication destination in accordance with the instruction received by the receiving unit.

Further example embodiments of the present invention provide a non-transitory recording medium storing a communication apparatus control program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a communication system that includes communication apparatuses as an embodiment of the present invention.

FIG. 2 is a diagram illustrating a hardware configuration of the communication apparatus in FIG. 1 as an embodiment of the present invention.

FIG. 3 is a diagram illustrating a functional configuration related to communication with other communication apparatuses that the communication apparatus in FIG. 1 includes as an embodiment of the present invention.

FIGS. 4A and 4B are sequence diagrams illustrating instructing the communication apparatus 10a and a communication apparatus 10c to start connecting from the viewpoint of the communication apparatus 10a as an embodiment of the present invention.

FIG. 5 is a sequence diagram illustrating an operation in case of No in S114 in FIG. 4B as an embodiment of the present invention.

FIG. 6 is a diagram illustrating history information that the communication apparatus 10a stores as an embodiment of the present invention.

FIG. 7 is a flowchart illustrating a process that the communication apparatus 10a executes as an embodiment of the present invention.

FIG. 8 is a sequence diagram illustrating the operation in accordance with FIGS. 4A and 4B from the viewpoint of the communication apparatus 10b as an embodiment of the present invention.

FIG. 9 is a diagram illustrating history information that the communication apparatus 10b stores as an embodiment of the present invention.

FIG. 10 is a diagram corresponding to FIG. 3 illustrating a functional configuration that a communication apparatus includes as another embodiment of the present invention.

FIG. 11 is a sequence diagram corresponding to FIG. 8 as the other embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In Wi-Fi Direct, it is desired to instruct the two apparatuses to be connected to start Wi-Fi Direct (to turn on Wi-Fi Direct mode) each time they connect and that has been a complicated procedure that took time.

It is possible that a problem the same as that described above occurs in case of using not only Wi-Fi Direct but also other communication standards that have the same characteristics. Of course, it is possible that the same problem occurs even if the apparatuses that perform communication are not printers and PCs as described above.

In the following embodiment, it is possible to configure settings for communication between communication apparatuses easily and promptly.

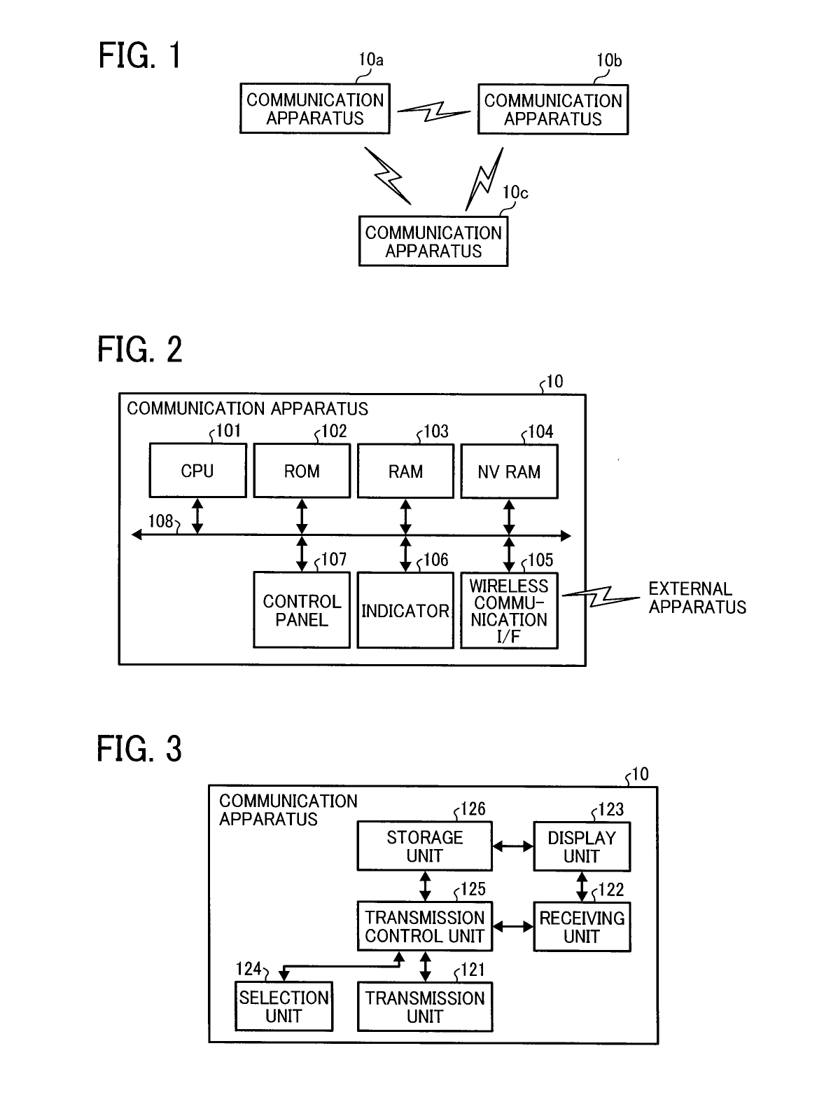

First, FIG. 1 is a diagram illustrating a communication system that includes communication apparatuses in this embodiment.

The communication system in FIG. 1 includes three communication apparatuses 10a, 10b, and 10c. In this embodiment, these three communication apparatuses 10a, 10b, and 10c can perform wireless communication with each other.

It is unnecessary that the communication apparatuses 10a, 10b, and 10c be the same type of apparatuses. However, it is assumed that each of the communication apparatuses 10a, 10b, and 10c includes an equivalent communication function. If it is unnecessary to distinguish the individual apparatuses, they are referred to as “the communication apparatus 10”.

FIG. 2 is a diagram illustrating a hardware configuration of the communication apparatus 10 in FIG. 1 in this embodiment.

As shown in FIG. 2, the communication apparatus 10 includes a CPU 101, a ROM 102, a RAM 103, a nonvolatile RAM (NVRAM) 104, a wireless communication I/F 105, an indicator 106, and a control panel 107, and those components are connected with each other via a system bus 108.

The CPU 101 controls the entire communication apparatus 10 by executing a program stored in the ROM 102 or the NVRAM 104 using the RAM 103 as a work area, and various functions (such as functions described later with reference to FIG. 3) can be implemented thereby. For example, a function that stores connection information of a communication target connected before and connects to the same communication target using a simplified sequence subsequently can be implemented.

The ROM 102 and the NVRAM 104 are non-volatile storage media that store various programs executed by the CPU 101 and various data (described later).

The wireless communication I/F 105 is an interface for performing wireless communication with the other communication apparatus 10. For example, it is possible that the wireless communication I/F 105 is the interface for performing communication using Wi-Fi Direct.

The indicator 106 is an indicating unit that indicates operational condition and configuration settings of the communication apparatus 10, and the indicator 106 includes a liquid crystal display and lamps, etc.

The control panel 107 is an operational unit for accepting input. The control panel 107 can include various buttons, various switches, and a touch panel.

Next, FIG. 3 is a diagram illustrating a functional configuration related to communication with other communication apparatus 10 that the communication apparatus 10 includes in this embodiment. Functions shown in FIG. 3 are implemented by controlling the various pieces of hardware shown in FIG. 2 by executing a predetermined program with the CPU 101.

As shown in FIG. 3, the communication apparatus 10 includes a transmission unit 121, a receiving unit 122, a display unit 123, a selection unit 124, a transmission control unit 125, and a storage unit 126.

Among those units described above, the transmission unit 121 includes a function that transfers data and transfers data to a communication destination after receiving a request for transmission by the transmission control unit 125.

The receiving unit 122 includes a function for receiving data and passes data received from a communication source to the transmission control unit 125.

The display unit 123 includes a function that displays information on the communication apparatus that can be selected as the communication target based on information received from the other communication apparatus 10 and history information stored in the storage unit 126.

The selection unit 124 includes a function that accepts selection of the communication apparatus as the communication target among the communication apparatuses displayed by the display unit 123.

The transmission control unit 125 includes a function that determines what to do next and which data is to be transferred based on the data received by the receiving unit 122 and instructs the transmission unit 121 to transfer the data.

The storage unit 126 includes a function that stores the information on the target apparatus connected communication before. More specifically, the storage unit 126 stores a combination of information, i.e., Service Set IDentifier (SSID), an encryption key of a wireless Local Area Network (LAN), interface address, and Internet Protocol (IP) address for multiple target apparatuses.

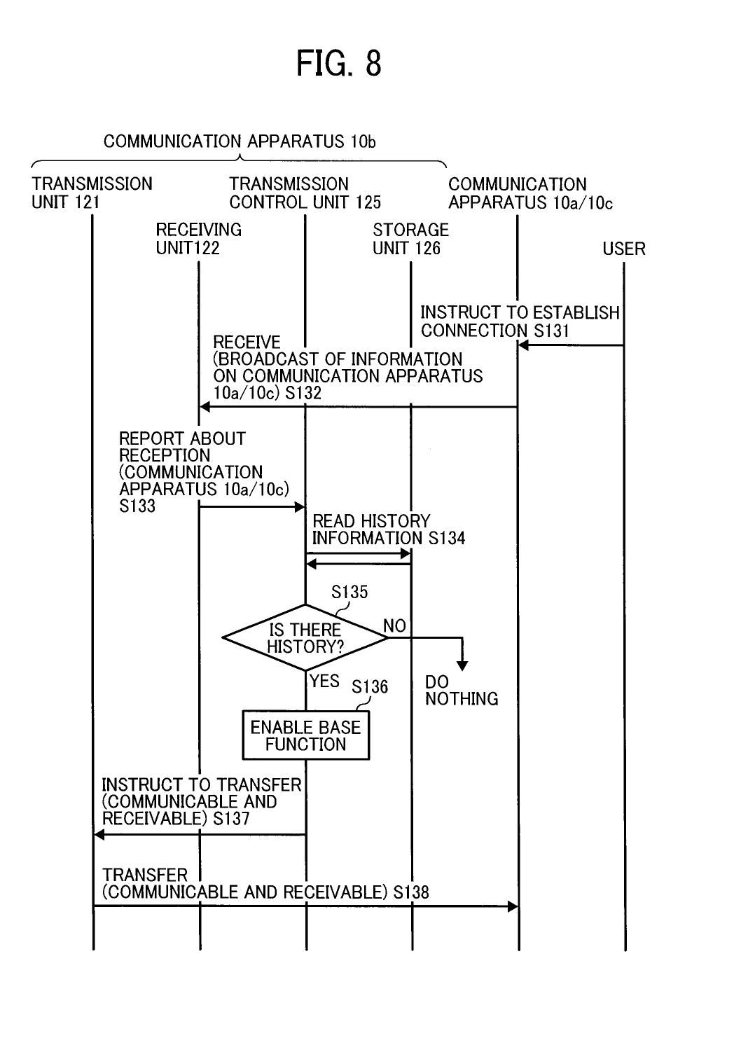

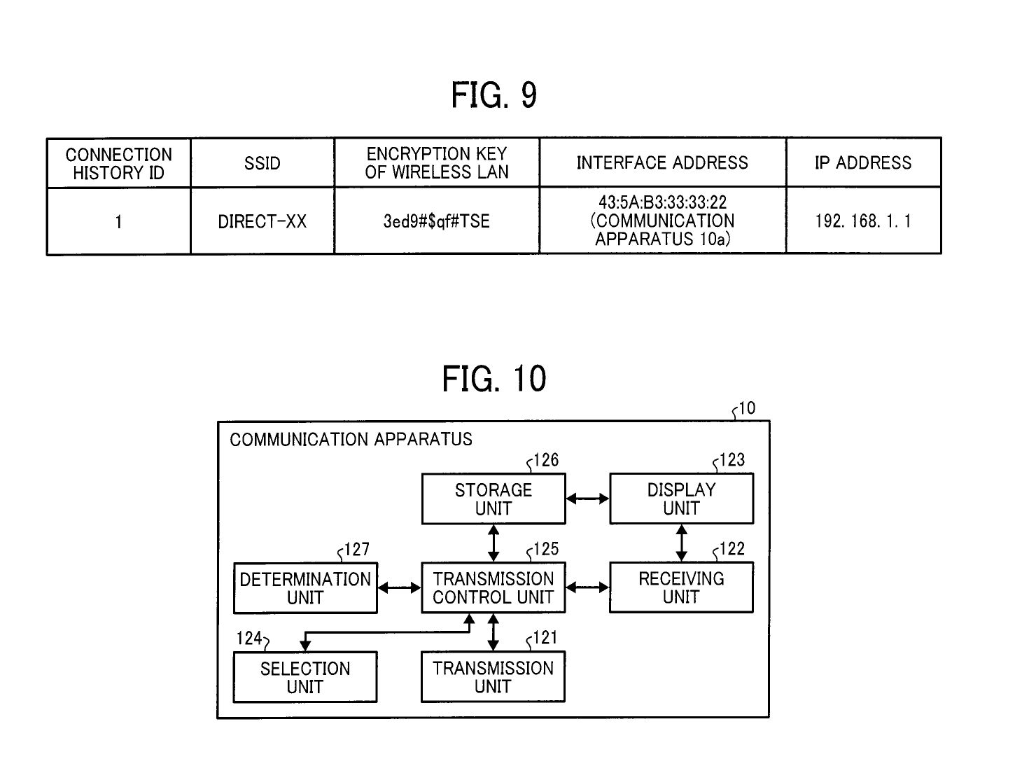

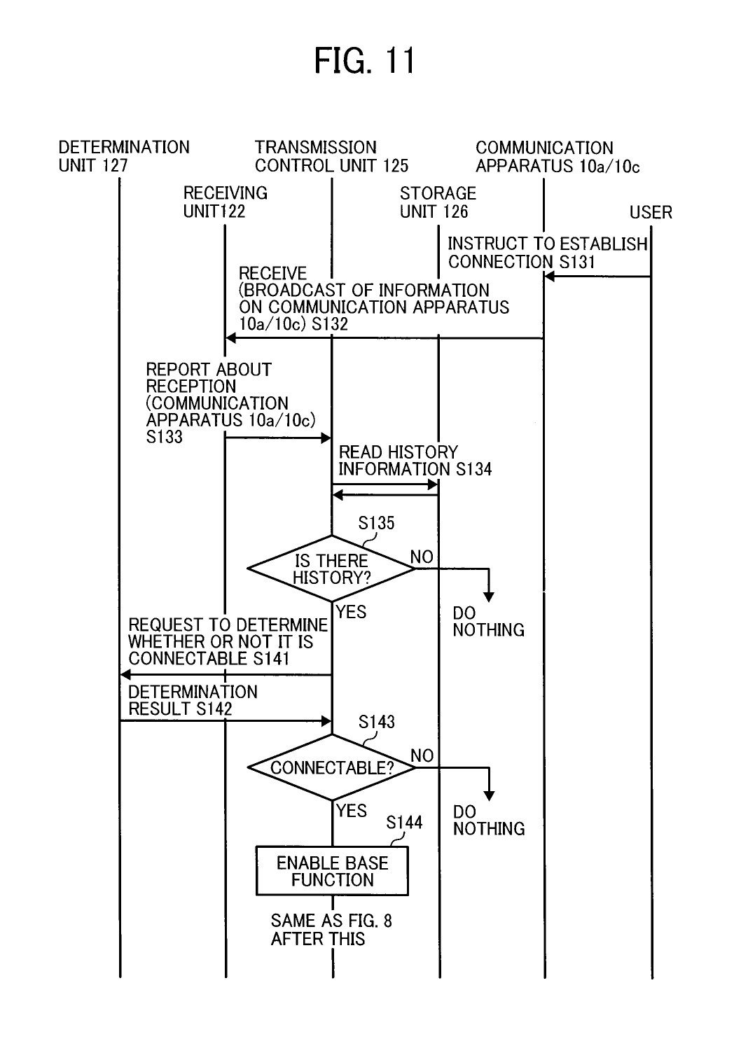

Next, a sequence in which the communication apparatus 10 starts communication with the other communication apparatus 10 is described below. Here, a sequence to establish communication using Wi-Fi Direct is described. However, it is possible to apply this embodiment in case of using other communication protocols. It should be noted that it is not a particular problem that the communication apparatuses 10a, 10b, and 10c include both the function to request the other communication apparatus to connect in accordance with user instruction and the function to accept the request for connection in FIG. 8.

In addition, it is assumed that the communication apparatus 10a communicated with the communication apparatus 10b before and stores the connection information as the history information with each other in establishing communication, and that the communication apparatus 10c has not communicated with either the communication apparatus 10a or the communication apparatus 10b yet.

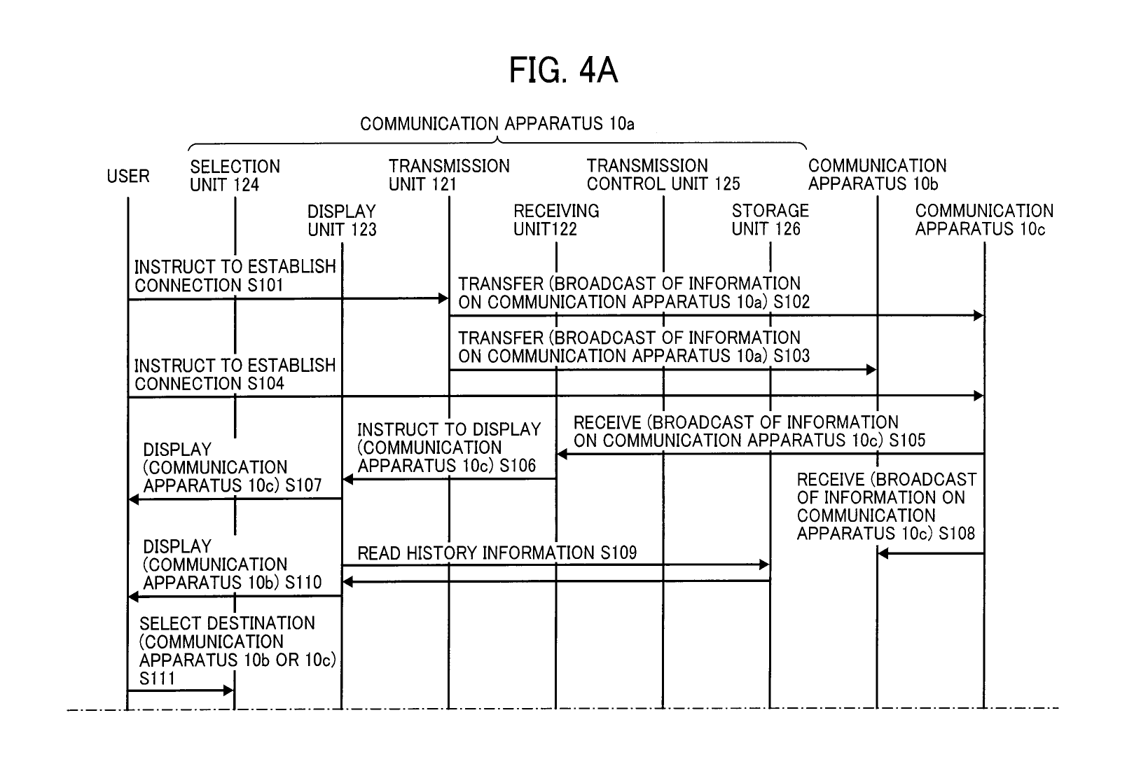

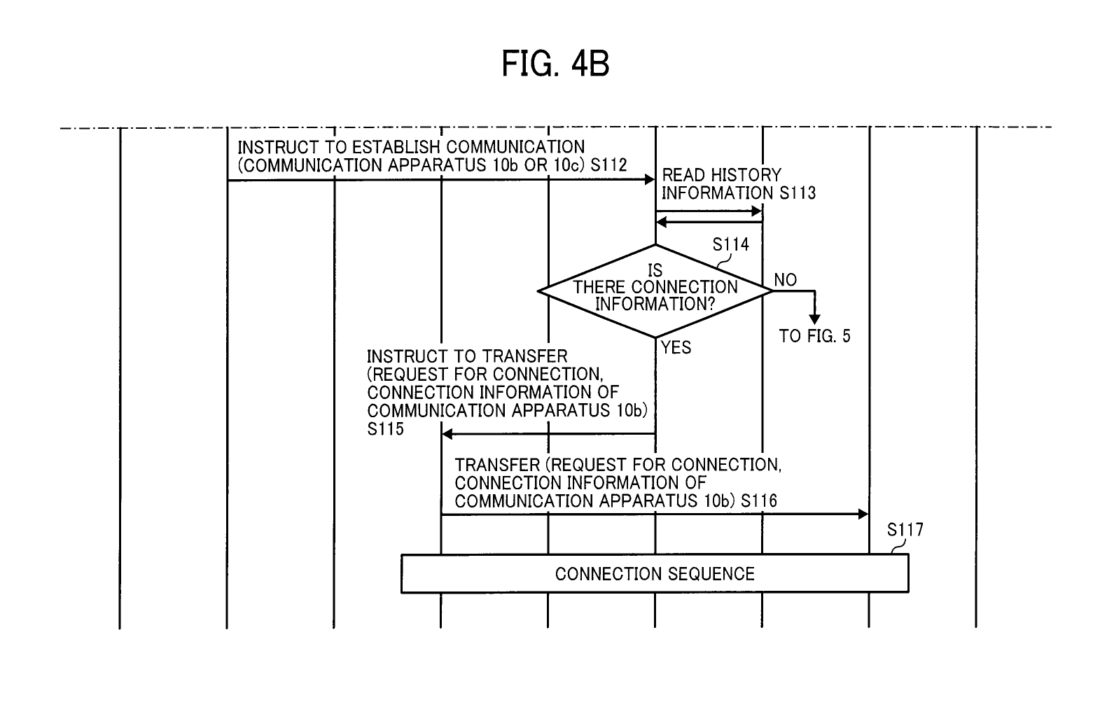

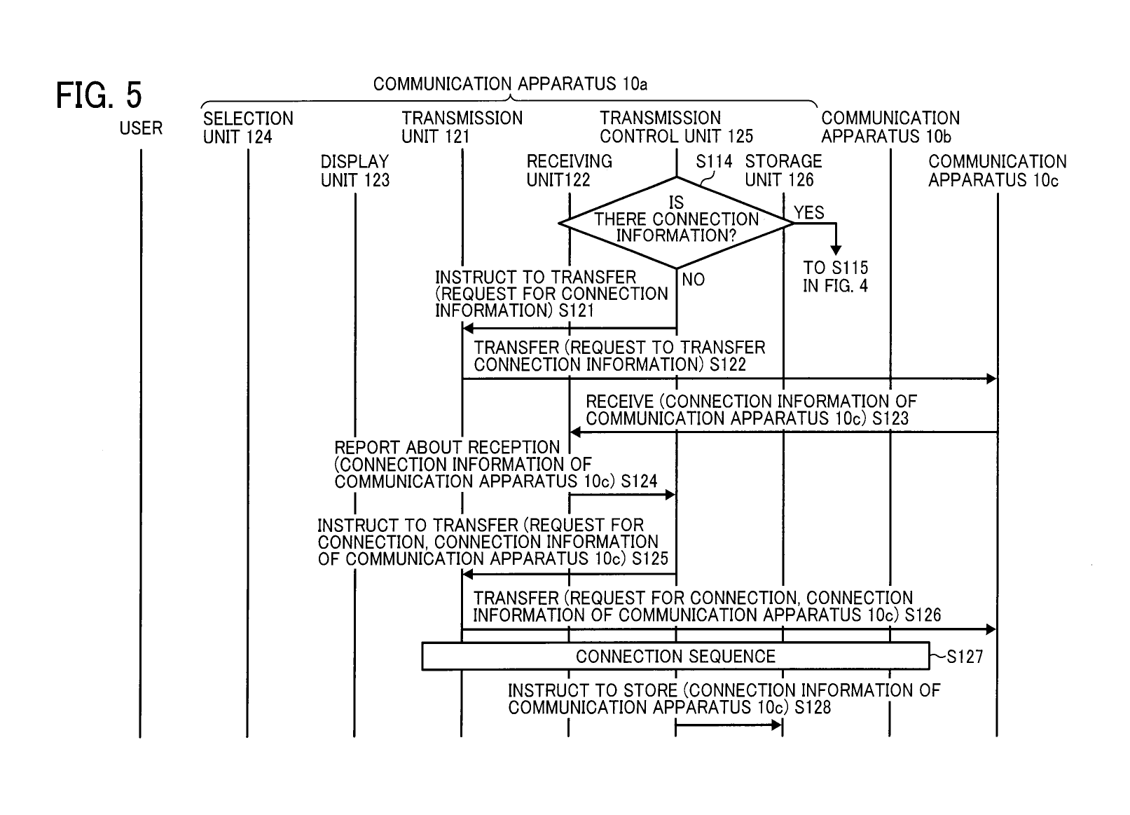

First, FIGS. 4A and 4B are sequence diagrams illustrating instructing the communication apparatus 10a and a communication apparatus 10c to start connecting from the viewpoint of the communication apparatus 10a in this embodiment.

After instructing to establish communication using Wi-Fi Direct by user operation on the control panel 107, the communication apparatuses 10a, 10b, and 10c transfer connectivity information that indicates it is possible to establish communication to surrounding external apparatuses.

In FIGS. 4A and 4B, an instruction on establishing a connection in S101 is the instruction to the communication apparatus 10a on establishing communication. Subsequently, the transmission unit 121 in the communication apparatus 10a functions as a transmitting unit and broadcasts interface address of the communication apparatus 10a to the surrounding communication apparatuses (i.e., the communication apparatus 10b and the communication apparatus 10c in this case) in S102 and S103. It should be noted that the broadcast is performed not to a specific apparatus but to the surrounding apparatuses across the board using wireless transmission.

The instruction on establishing a connection in S104 is performed by user operation on the communication apparatus 10c. In communication apparatus 10c, just like the communication apparatus 10a, the transmission unit broadcasts interface address of the communication apparatus 10c to the surrounding communication apparatuses (i.e., the communication apparatus 10a and the communication apparatus 10b in this case) in S105 and S108.

In the communication apparatus 10a, the receiving unit 122 receives the broadcast. Consequently, the receiving unit 122 recognizes that the communication apparatus 10c can establish communication and instructs the display unit 123 to display the communication apparatus 10c on the list of apparatuses selectable as the communication target in S106. Accordingly, the display unit 123 displays the communication apparatus 10c on the list of apparatuses selectable as the communication target and enables the communication apparatus 10c to be selected.

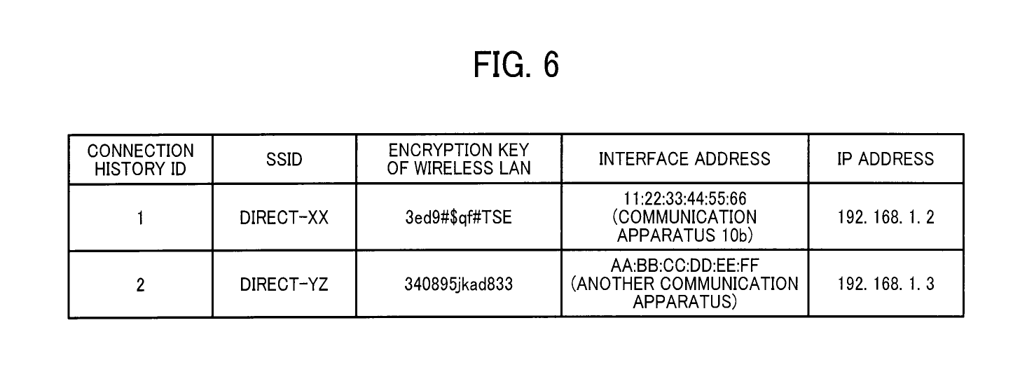

In addition, apart from the instruction on displaying in S106, the display unit 123 reads history information in FIG. 6 from the storage unit 126 in S109 and displays the communication apparatus whose connection information (information desired for connecting communication with the communication apparatus) is registered in the history information on the list of apparatuses selectable as the communication target in S110. That is, the list of apparatuses selectable as the communication target includes the apparatus that broadcasts the interface address received by the receiving unit 122 and apparatuses whose connection information is registered in the history information.

In FIGS. 4A and 4B, the list includes the communication apparatus 10c as the broadcast origin and the communication apparatus 10b as the apparatus whose connection information is registered. Subsequently, it is possible to select either the communication apparatus 10c or the communication apparatus 10b as the communication target apparatus (connection destination of communication) by user operation. The selection unit functions as a reception unit and receives the selection.

After selecting either the communication apparatus 10c or the communication apparatus 10b as the destination apparatus by user operation, the selection unit 124 detects the selection in S111 and instructs the transmission control unit 125 to establish communication with the destination apparatus in S112.

After receiving the instruction, the transmission control unit 125 reads the history information in FIG. 6 from the storage unit 126 in S113 and determines whether or not the connection information of the instructed destination apparatus exists in the history information in S114. If the connection information exists (i.e., if the destination apparatus is the communication apparatus 10b), in order to request the destination apparatus to establish communication using the connection information in the history information, the transmission control unit 125 instructs the transmission unit 121 to transmit the request for connection using the connection information in S115. The transmission unit 121 transmits the request for communication to the destination apparatus in accordance with the instruction in S116. In S115 and S116, the transmission control unit 125 and the transmission unit 121 function as a first request unit.

Here, after performing an operation in FIG. 8 (described later), the communication apparatus 10b as the destination apparatus is supposed to accept the request for communication from the communication apparatus 10a as the base of Wi-Fi Direct in accordance with the information broadcast that the communication apparatus 10a transfers in S103. Therefore, subsequently, the communication apparatus 10a as the slave establishes connection with the communication apparatus 10b as the base in accordance with the connection sequence of Wi-Fi Direct (of which a detailed description is omitted). After that, it is possible to exchange all types of information between the communication apparatus 10a and the communication apparatus 10b using the communication channel of Wi-Fi Direct.

As described later, the connection sequence of the communication in S115 and S116 shortcuts a part of the normal connection sequence of Wi-Fi Direct using the connection information in the history information.

By contrast, if the connection information does not exist in S114 (i.e., if the destination apparatus is the communication apparatus 10c), communication connection is established with the destination apparatus using the normal connection sequence of Wi-Fi Direct as shown in FIG. 5.

That is, first, the transmission control unit 125 instructs the transmission unit 121 to transfer the request for the connection information to the destination apparatus in S121. In response to the instruction, the transmission unit 121 transfers the request for the connection information to the communication apparatus 10c in S122.

After receiving the request, the communication apparatus 10c transfers the connection information of the communication apparatus 10c, and the receiving unit 122 receives the connection information in S123. The receiving unit 122 reports to the transmission control unit 125 about the received connection information in S124.

After receiving the report, in order to request the destination apparatus to establish communication using the received connection information, the transmission control unit 125 instructs the transmission unit 121 to transmit the request for connection using the connection information in S125. The transmission unit 121 transmits the request for communication to the destination apparatus in accordance with the instruction in S126. In S121 and S126, the transmission control unit 125, the receiving unit 122, and the transmission unit 121 function as a second request unit.

Subsequently, the communication apparatus 10a establishes connection with the communication apparatus 10c in accordance with the connection sequence of Wi-Fi Direct (of which a detailed description is omitted). After that, it is possible to exchange all types of information between the communication apparatus 10a and the communication apparatus 10c using the communication channel of Wi-Fi Direct. It is determined that which apparatus becomes the base, the communication apparatus 10a or the communication apparatus 10c after the negotiation between the apparatuses appropriately.

If the communication connection is established between the communication apparatus 10a and the communication apparatus 10c, the transmission control unit 125 instructs the storage unit 126 to store the connection information received from the communication apparatus 10c as the history information in S128. In response to the instruction, the storage unit 126 stores the connection information of the communication apparatus 10c as the connection information acquired from the destination apparatus with which communication was performed before for establishing the communication with the destination apparatus. Likewise, the information of the communication apparatus 10a is stored in the communication apparatus 10c.

Consequently, the determination in S114 becomes yes from then onward in case of establishing communication with the communication apparatus 10c next time, and it is possible to establish the connection in which a part of the sequence can be omitted just like in steps S115 to S117 in FIG. 4B. In addition, in establishing connection, it is unnecessary to instruct the communication apparatus 10c to establish a connection by user operation. Consequently, it is possible to reduce a burden on user operation and establish connection promptly.

FIG. 6 is a diagram illustrating the history information that the storage unit 126 stores in this embodiment.

As shown in FIG. 6, the history information includes a connection history ID, the SSID, the encryption key of a wireless LAN, interface address, and IP address. Among the information, the connection history ID is identification information to identify each history, and other information is the connection information to establish communication connection with the destination apparatus. In addition, the interface address can be used as the identification information to specify the apparatus.

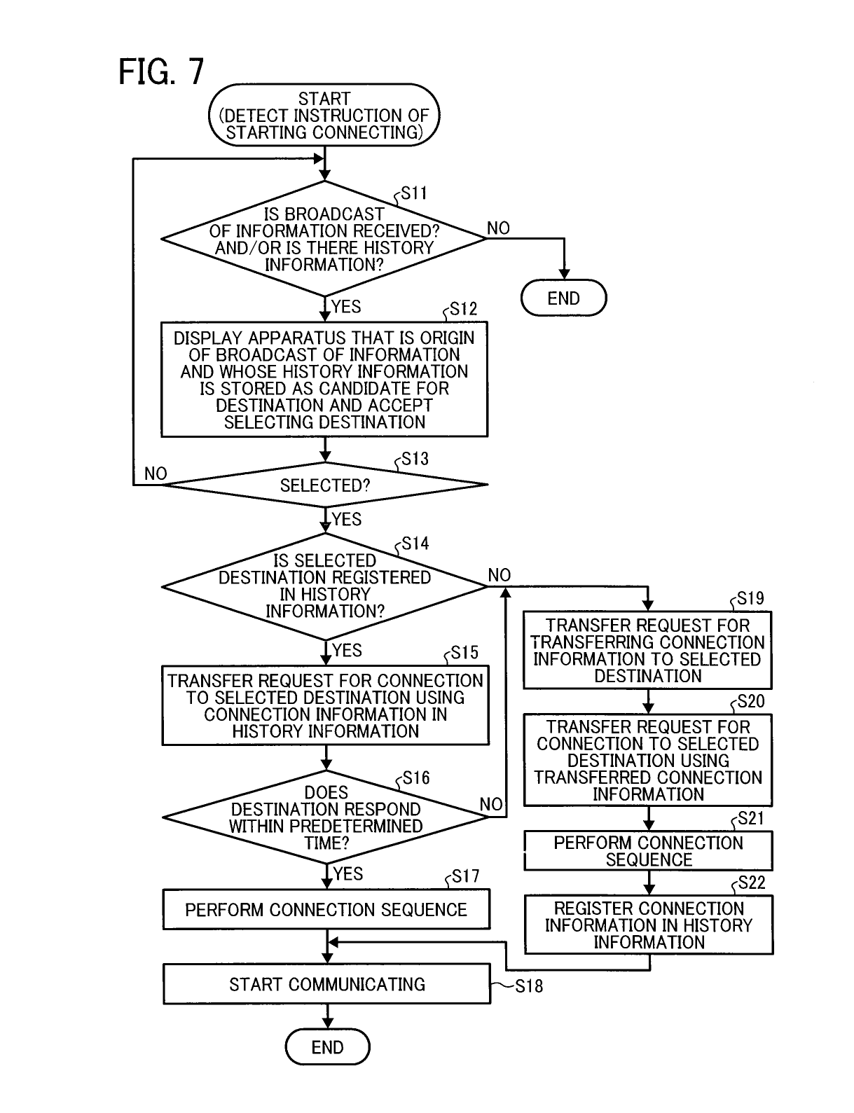

FIG. 7 is a flowchart illustrating a process that the communication apparatus 10a executes to perform the operation in FIGS. 4 and 5 in this embodiment. The process is implemented by controlling the hardware in FIG. 2 by executing a predetermined program by the CPU 101 and functioning units in FIG. 3.

The process in FIG. 7 starts after the instruction to the communication apparatus 10a on establishing a connection in S101 in FIG. 4A by user operation.

In FIG. 7, first, the CPU determines whether or not the broadcast information is received from another apparatus and/or the storage unit 126 stores the history information in S11. If at least one condition is satisfied, the apparatus as the origin of the broadcast information and whose connection information is stored as the history information is displayed as the candidate, and it is accepted to select the communication destination by user operation in S12. Subsequently, the steps S11 to S13 are repeated until the selection is received.

If no apparatus can be detected in S11, the CPU 101 determines that it is impossible to establish communication with other apparatuses at this point, and the process ends. In this case, the CPU 101 waits for receiving the broadcast information for a certain period of time.

By contrast, if there is a selection in S13, the CPU 101 determines whether or not the history information is registered for the selected communication destination in S14. If the history information is registered, the CPU 101 transfers the request for connection to the selected communication destination using the connection information in the history information in S15. Subsequently, if there is a response from the communication destination within a predetermined period of time (YES in S16), the connection sequence of Wi-Fi Direct is performed with the communication destination in S17. After connecting communication by the sequence, the communication is started using the connected channel in S18.

By contrast, if the history information is not registered in S14, the CPU 101 transfers the request for transferring the connection information to the selected communication destination in S19. Subsequently, the CPU 101 transfers the request for connection to the communication destination using the connection information that the communication destination transfers in accordance with the request in S20. After that, the connection sequence of Wi-Fi Direct is performed with the communication destination in S21. After connecting communication, the connection information used for the connection is registered as the history information in S22, and communication is started using the connected channel in S18. This sequence described above is the normal connection sequence of Wi-Fi Direct.

In addition, if there is no response within the predetermined period of time in S16, it is considered as timeout, and the process proceeds to S19. Subsequently, it is tried to establish connection using the normal connection sequence. If the communication destination is incompatible with the connection sequence using the history information, it is considered that the communication destination does not respond to the request for connection in S15 and it is possible to establish connection using the normal connection sequence.

In each case, the process ends after S18.

By comparing steps S15 to S17 with steps S18 to S20, in case of establishing communication with the communication target whose history information is registered, the sequence that transfers the request for transferring the connection information and receives the connection information transferred in response to the request can be omitted. In addition, in the normal connection sequence, the sequence of negotiation that determines which communication apparatus becomes the base is included, and that takes time. However, in case of establishing communication with the communication destination whose history information is registered, the negotiation sequence is unnecessary since it is determined preliminarily which apparatus becomes the base (i.e., the apparatus that receives the request for establishing communication becomes the slave, and its communication destination becomes the base).

Consequently, in case of connecting using the history information, it is possible to shortcut the period of time for connecting communication substantially.

Next, FIG. 8 is a sequence diagram illustrating the operation in accordance with FIGS. 4A and 4B from the viewpoint of the communication apparatus 10b in this embodiment. The sequence is an operational sequence in the base apparatus after connecting communication using the history information.

It is unnecessary to instruct the apparatus that becomes the base to establish a connection particularly. In addition, after instructing the other communication apparatuses 10a and 10c to establish a connection, the communication apparatuses 10a and 10c broadcasts information in response to the instruction, and the receiving unit 122 in the communication apparatus 10b receives the broadcast information in S132. Subsequently, the receiving unit reports to the transmission control unit 125 about the content of the broadcast information in S133.

After receiving the notification, the transmission control unit 125 reads the history information from the storage unit 126 in S134. If there is the history information of the apparatus that broadcasts information (YES in S135), the base function of the communication apparatus 10b is enabled in S136, and the communication apparatus 10b as the base of Wi-Fi Direct transitions to a state that waits for communication connection from the slave. That is, the communication apparatus 10b transitions to a state that can establish communication in accordance with the connection request that omits a part of the normal connection sequence of Wi-Fi Direct transferred in S116 in FIG. 4B. In the operation described above, the transmission control unit 125 functions as a transition unit.

In addition, to indicate that the communication apparatus 10b is in the state described above, the transmission control unit 125 instructs the transmission unit 121 to transfer a signal indicating that it is possible to receive connection in S137, and the transmission unit 121 transfers the signal in accordance with the instruction in S138. For example, a probe response can be used for the signal. In addition, it is possible that the transmission is performed not to a specific apparatus but to the surrounding apparatuses.

Here, assuming the history information stored in the communication apparatus 10b is shown in FIG. 9, the determination in S135 becomes YES if the broadcast information is received from the communication apparatus 10a, and the determination in S135 becomes NO if the broadcast information is received from the communication apparatus 10c.

In case of NO in S135, the communication apparatus 10b does nothing particularly at this point. In case of receiving the request for transferring the connection information transferred in S122 in FIG. 5, the normal connection sequence is performed in response to the request. If there is no instruction of establishing a connection by user operation, it is unnecessary for the communication apparatus 10b to perform the operation for establishing connection spontaneously.

In FIG. 8, in case of YES in S135, it is possible that the communication apparatus 10a becomes communicable with the communication apparatus 10b without performing any operation on the communication apparatus 10b by user operation. While it is desired to instruct the communication apparatus 10a to establish a connection and select the communication destination on the communication apparatus 10a, it is possible to reduce a burden of operation substantially compared to the normal connection sequence of Wi-Fi Direct that is desired to instruct both the communication apparatus 10a and the communication apparatus 10b to establish a connection.

After enabling the base function in S136, if there is no request for connection from the communication apparatus 10a within the predetermined period of time, it is preferable to disable the base function and terminate the status that can establish communication by the CPU 101 according to a program stored in the ROM 102 or the NVRAM 104. Since other apparatuses incompatible with the connection function that omits the part of the sequence in FIGS. 4A and 4B also broadcast information, it is possible that apparatuses registered in the history information do not always request connection that omits part of the sequence.

In the embodiment described above, the specific configuration of the apparatuses, the specific sequence of the processes, the number of apparatuses used in the embodiment, and the configuration of data used in the embodiment etc. are not limited to the above description.

For example, in performing the process in FIG. 8, it is preferable to determine whether or not it is possible to transition to a status in which communication can be established in case of YES in S135 under certain conditions.

In this case, as shown in FIG. 10, a determination unit 127 is added to the functions shown in FIG. 3. In case of receiving the broadcast information from the destination apparatus whose history information is registered, the determination unit 127 functions as a determination unit that determines whether or not to transition to the status that can establish communication with the destination apparatus in accordance with the request for connection from the destination apparatus.

FIG. 11 is a sequence diagram corresponding to FIG. 8 in case of including the determination unit 127.

Steps S131 to S135 in FIG. 11 are the same as in FIG. 8. In case of YES in S135, the transmission control unit 125 requests the determination unit 127 to determine whether or not it is possible to connect in S141. The step is the equivalent of a request to determine whether or not to transition to the status that can establish communication described above. The determination unit 127 performs the determination based on predetermined criteria and outputs the determination result in S142.

If it is possible to connect (YES in S143), the transmission control unit 125 enables the base function in S144 just like the case in FIG. 8, and the process proceeds to the following steps. In case of NO in S143, just like the case of NO in S135, the communication apparatus 10b does nothing particularly at this point.

In FIG. 8, in case of YES in S135, since the reception of the broadcast information is the only trigger for transitioning to the status that can connect, it is possible to establish communication promptly depending on using the apparatus, and that can cause a problem in some cases. Therefore, just like the case in FIGS. 10 and 11, it is more preferable that it is possible to determine whether or not to transition to the status that can connect considering other conditions.

It is possible to perform the determination in accordance with a setting on whether or not it is possible to transition by user operation (a first determination unit). For example, the setting can be configured preliminarily and stored, or it is possible to select whether or not it is possible to transition in case of performing the determination actually.

Otherwise, it is possible to perform the determination in accordance with the other process that the communication apparatus 10b executes when it is requested to determine in S141 (a second determination unit). For example, priorities are set to the processes that the communication apparatus 10b executes depending on the type of the process, and it is impossible to transition to the status that can connect during the execution of the process whose priority is higher than a predetermined level.

It is possible that the function of connecting communication between the communication apparatuses described above can be implemented as the communication function using the Wi-Fi Direct. However, it is possible that the function is implemented as the function that performs communication compatible with other specifications. It is also possible to implement a vendor-original function that connects the apparatuses easily. Especially in the latter case, it is not required that the communication apparatus can perform the connection sequence corresponding to “the normal connection sequence using Wi-Fi Direct” described above.

In addition, the functions of the communication apparatus 10 described above can be distributed to multiple apparatuses, and it is possible for the apparatuses to collaborate with each other and implement the same functions as the communication apparatus 10. In this case, those multiple apparatuses correspond to the embodiment of the communication system. In addition, it is possible the communication system consists of one apparatus only.

The present invention also encompasses an information processing method. The method includes the steps of transferring connectivity information indicating that communication can be established, storing connection information for establishing communication with a previous communication destination acquired from the previous communication destination, accepting an instruction to establish communication with a communication destination whose connection information is stored while transferring the connectivity information, requesting the communication destination to establish communication using the connection information stored in accordance with the instruction received, and transitioning to a status in which communication can be established with the communication destination in response to a request for connection by the communication destination in case of receiving the connectivity information from the communication destination whose connection information is stored.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. A communication apparatus, comprising:
a transmission unit to transmit connectivity information indicating that communication can be established;
a storage unit to store connection information for establishing communication with a previous communication destination acquired from the previous communication destination;
an acceptance unit to accept an instruction to establish communication with a communication destination whose connection information is stored in the storage unit while the transmission unit is transferring the connectivity information; and
a first request unit to request the communication destination to establish communication using the connection information stored in the storage unit for the communication destination in accordance with the instruction received by the receiving unit.

2. The communication apparatus according to claim 1, wherein the communication apparatus transfers a request for transferring the connection information to the communication destination if the communication destination does not respond within a predetermined period of time after the first request unit requests the communication destination to establish communication.

3. The communication apparatus according to claim 1, further comprising:
a receiving unit to receive the connectivity information from an external apparatus, wherein the acceptance unit accepts the instruction on the destination with which communication is connected among the external apparatus whose connectivity information is received by the receiving unit and the communication destination whose connection information is stored in the storage unit; and
a second request unit to transfer the request for transferring the connection information to the external apparatus in case of accepting the instruction to regard the external apparatus whose connectivity information is received by the receiving unit as the communication destination and request the external apparatus to establish communication using the connection information transferred in accordance with the request for transferring.

4. The communication apparatus according to claim 3, wherein the first request unit requests to establish communication by omitting to transfer the request for transferring the connection information to the communication destination.

5. The communication apparatus according to claim 1, further comprising:
a transition unit to transition to a status in which communication can be established with the communication destination in response to a request for connection by the communication destination in case of receiving the connectivity information from the communication destination whose connection information is stored in the storage unit.

6. The communication apparatus according to claim 5, further comprising a first determination unit to determine whether or not the transition unit can transition to the status in which communication can be established along with a predetermined setting.

7. The communication apparatus according to claim 5, further comprising a second determination unit to determine whether or not the transition unit can transition to the status in which communication can be established in accordance with another process that is performed when the connectivity information is received from the communication destination whose connection information is stored in the storage unit.

8. The communication apparatus according to claim 5, further comprising a termination unit to terminate the status in which communication can be established if there is no request for connection by the communication destination within a predetermined period of time after the transition unit transitions to the status in which communication can be established.

9. The communication apparatus according to claim 1, wherein the connectivity information and the request for connection are compatible with a Wi-Fi Direct communication protocol.

10. A communication system, comprising:
a transmission unit to transmit connectivity information indicating that communication can be established;
a storage unit to store connection information for establishing communication with a previous communication destination acquired from the previous communication destination;
an acceptance unit to accept an instruction to establish communication with a communication destination whose connection information is stored in the storage unit while the transmission unit is transferring the connectivity information;
a request unit to request the communication destination to establish communication using the connection information stored in the storage unit for the communication destination in accordance with the instruction received by the receiving unit; and
a transition unit to transition to a status in which communication can be established with the communication destination in response to a request for connection by the communication destination in case of receiving the connectivity information from the communication destination whose connection information is stored in the storage unit.

11. A non-transitory, computer-readable recording medium storing a program that, when executed by a processor, causes the processor to implement a method of processing information, the method comprising the steps of:
transferring connectivity information indicating that communication can be established;
storing connection information for establishing communication with a previous communication destination acquired from the previous communication destination;
accepting an instruction to establish communication with a communication destination whose connection information is stored while transferring the connectivity information;
requesting the communication destination to establish communication using the connection information stored in accordance with the instruction received; and
transitioning to a status in which communication can be established with the communication destination in response to a request for connection by the communication destination in case of receiving the connectivity information from the communication destination whose connection information is stored.
